(19) United States
(12) Patent Application Publication
(10) Pub. No.: US 2002/0137411 A1
(43) Pub. Date: Sep. 26, 2002

(54) Method for forming coating with embedded particles

(76) Inventor: Pasquale Capra, Wickliffe, OH (US)

Correspondence Address: BROUSE MCDOWELL, INTELLECTUAL PROPERTY GROUP, 500 FIRST NATIONAL TOWER, AKRON, OH, 44308, US

(21) Appl. No.: 10/102,904

(22) Filed: Mar. 20, 2002

Related U.S. Application Data
(60) Provisional application No. 60/277,248, filed on Mar. 20, 2001.

(51) Int. Cl. D04H 1/00; B32B 5/16

(52) U.S. Cl. 442/74; 442/72

(57) ABSTRACT

A synthetic coated surface product which includes a substrate, an interface layer which is a polymeric composition that has penetrated the substrate layer to a sufficient depth to inhibit delamination, and a layer of granules mixed with a polyester resin supported on the interface layer. The surface can be left as cured and unfinished for a rough finish, subsequently sanded to provide a matte finish, or after sanding, polished for a shiny finish.

### CROSS REFERENCE TO RELATED APPLICATION

This is a non-provisional of copending patent application Ser. No. 60/277,248, filed Mar. 20, 2001, entitled “Method for Forming Coating with Embedded Particles.”

### BACKGROUND OF THE INVENTION

The present invention relates to a method of forming a synthetic surface material simulating various natural substances, such as stone, granite, and the like, and more particularly to a method of creating a solid surface which takes on the shape of an underlying substrate.

Processes for the manufacture of simulated marble are well known in the art. They involve forming veins or striations in a resin matrix to create a marble-like appearance. Similarly, processes for the manufacture of tiles or slabs using pieces of solid decorative material bonded together with a binder are also known.

U.S. Pat. No. 4,244,993 to Platka, III, et al. teaches a method for the manufacture of simulated marble and onyx products. A mold is initially coated with a gelcoat. A mixture of a polyester resin and a filler is sprayed over the gel coat. Veins are then formed in this layer, and glass fiber, polyester resin, and filler are then deposited thereon.

U.S. Pat. No. 5,476,895 to Ghahary discloses a method of spray coating a synthetic surface material, which mimics the appearance of granite. The coating comprises a gel coat mixed with granules formed from a combination of a thermoplastic and a thermoset plastic. A filler, such as an aluminum trihydrate material, is added to mask the colorations of the surface to be sprayed.

When coating porous materials, such as wood and particleboard, it is common to apply a barrier coat to the substrate to prevent penetration of the resin into the substrate and to isolate contaminants. The present inventor has found, however, that over time, such coatings tend to delaminate from the substrate.

The present invention provides a new and improved method for forming a coating and coated product, which overcome the above-referenced problems and others.

### SUMMARY OF THE INVENTION

The present invention is directed to a method for forming a synthetic surface which simulates natural substances such as stone, granite, marble, and the like to produce a synthetic surface that has a reduced risk of delamination and cracking. The process includes the steps of applying a first coating layer, which is a thermosetting polymeric composition, allowing the polymeric composition to penetrate into the substrate and form an interface layer, applying a layer of resin mixed with granules over the first coating layer, preferably before the first layer is completely set, and curing the resulting laminate. The thermosetting polymeric composition is preferably as a polyester resin and an accelerator, which is added in sufficient quantity to cause the resin to set, while allowing time for the resin to penetrate into the substrate and form the interface layer.

The synthetic surface is a coated product which includes a substrate, an interface layer which is a polymeric composition that has penetrated the substrate layer to a sufficient depth to inhibit delamination, and a layer of granules mixed with a polyester resin supported on the interface layer. The surface can be left as cured and unfinished for a rough finish, subsequently sanded to provide a matte finish, or after sanding, polished for a shiny finish.

Still further advantages of the present invention will become apparent to those of ordinary skill in the art upon reading and understanding the following detailed description of the preferred embodiments.

### DETAILED DESCRIPTION OF THE PREFERRED EMBODIMENTS

The present invention is directed to a method for forming a synthetic surface which simulates natural substances such as stone, granite, marble, and the like to produce a synthetic surface that has a reduced risk of delamination and cracking. As used herein, the term “granite” is meant to include natural granite, synthetic granite, and a mixture of natural and synthetic granite, unless otherwise noted. While the invention is described with particular reference to the formation of countertops, it will be appreciated that the coating can also be used in the manufacture of any type of product having a simulated synthetic surface, such as bathtubs, toilets, furniture, tiles, fireplaces, stair treads, ornamental pillars, garden furniture and ornaments, and the like.

The process includes the steps of applying a first a thermosetting polymeric composition coating layer, allowing the polymeric composition to penetrate into the substrate and form an interface layer, applying a layer of resin mixed with granules over the first coating layer, and curing the resulting laminate.

Suitable substrate materials include wood, particle board, cardboard, PVC plastics, synthetic polymeric substrates, such as polyester, acrylic, and the like, engineered wood products, fiber board, engineered synthetic building products, and the like compositions made from wood or natural fibers and having a degree of porosity or permeability which will allow the first coating material to penetrate. The synthetic surface of the present invention can be applied to a wide variety of substrates. If the substrate inherently possesses porosity or permeability, then the synthetic surface of the present invention can be applied. If the surface is not porous or permeable, then the use of sanding or solvents can physically or chemically produce the necessary permeability. Engineered synthetic building products could include synthetic products that have been engineered to provide certain performance or safety characteristics such as fire resistance, weight reduction or the like. Thus, for example, the synthetic surface of the present invention could be applied to an existing polyester or acrylic surface if the surface is out dated or worn. By “permeable,” it is meant that the first coating material is able to penetrate the substrate and form a substrate-coating interface in a surface layer of the substrate. The penetration may occur by infiltration into pores of the substrate or by dissolution or other interaction with a portion of the substrate. Preferably, complete dissolution of the substrate does not occur, or the shape of the product may be compromised. For materials such as wood and particleboard substrates, the polyester resin tends to infiltrate both by permeation of pores and also by dissolving portions of the wood, such as resins. This infiltration of the wood forms a rigid intermediate structure.

The present invention will be discussed as a coated product, such as a countertop. To form the coated product, a first coating material, preferably a thermoset polymer, such as a polyester resin, is applied to a permeable substrate. A further coating forms an interface layer of unpenetrated coating material on top of the substrate. For convenience, coatings are often applied as thin coatings, which together form the first layer. Usually each coating is indistinguishable from the subsequent only and giving the impression of one layer. Because of the permeable surface, the first coating or coatings of material are able to penetrate the substrate and form a substrate-coating interface in a surface layer of the substrate. A second coating layer is applied over the first layer to give the product a granite-like appearance.

The first coating material preferably comprises a thermosetting polymeric composition composed of, preferably, a polyester resin and an accelerator or promoter, which is added in sufficient quantity to cause the resin to set, while allowing time for the resin to penetrate into the substrate and form the interface layer. The composition will be adjusted depending upon the working conditions since on warmer days the same composition will set faster and on cold days slower. But, the composition is selected so that it provides a penetration of 0.5 to 4 millimeters (mm), preferably 2 to 3 mm. The composition may additionally include a catalyst, fillers, colorants, and the like. The polymeric material (typically an oligomer), a catalyst, and an accelerator (promoter), which are stored separately prior to use and are combined in appropriate amounts to form the coating material. Preferably, the polymer or polymeric resin, when fully cured, provides desirable heat, chemical, and moisture resistance. Although the coating is primarily intended to be sprayed, it may also be applied by brush, roller, curtain wall, or the like. Typically for these types of compositions, the coating will be applied as several thin layers to build up to the appropriate thickness. For example, 6 or 7 layers or coats may be applied. It is the first 1 or 2 layers that are critical to obtain penetration into the substrate.

Preferred polymer materials include polyester resins, neopentyl resins, glycol resins, and other isophthalic resins, acrylic polymers, such as methyl methacrylate, and epoxy resin systems. Other possible polymeric resins include also contemplated provided that the various resin components are compatible with one another. Blends or mixtures of different polymeric resin compositions can be used. Suitable polyester resins include those prepared from polymerizable unsaturated polyesters such as those prepared from ethylenically unsaturated polycarboxylic acids and polyhydric alcohols. Unsaturated polyester resins are typically prepared by the reaction of an alpha, beta-ethylenically unsaturated dicarboxylic acid, or an admixture of such an acid with a saturated dicarboxylic acid, and a dihydric alcohol. Preferably, the unsaturated polyester resin is an isophthalic or orthophthalic polyester resin. More preferably, the unsaturated polyester resin is an isophthalic polyester resin. One such polyester resin comprises neopentyl glycol and isophthalic acid. A particularly preferred resin is a paraffined unsaturated polyester. Suitable unsaturated polyesters may be obtained from Safas Corporation, Clifton, N.J.; from Ilva Polimeri, Milan, Italy, under the tradename Acripol; or from Rovea Corp., Milan, Italy.

The first coating material can also include one or more compatible unsaturated monomers for crosslinking. Examples of such co-monomers include, for example: aromatic compounds such as styrene, alpha-methyl styrene, dichlorostyrene, vinyl naphthalene, vinyl phenol, and the like; unsaturated esters, such as acrylic and methacrylic esters, vinyl laurate, and the like; unsaturated acids such as acrylic and alpha-alkylacrylic acids, butenoic acids, allylbenzoic acid, vinylbenzoic acid, and the like; halides, such as vinyl chloride, vinylidene chloride, and the like; nitrites, such as acrylonitrile, methacrylonitrile, and the like; diolefins, such as butadiene, isoprene, methylpentadiene, and the like; esters of polycarboxylic acids such as diallyl phthalate, divinyl succinate, diallyl maleate, divinyl adipate, dichloroallyl tetrahydrophthalate, and the like; and mixtures thereof.

Suitable catalysts include conventional free radical polymerization initiators, such as organic peroxides, hydroperoxides, and azo compounds. Preferred catalysts are organic peroxides and hydroperoxides. More preferably, suitable catalysts are selected from the group consisting of benzoyl peroxide, dicumyl peroxide, methyl ethyl ketone peroxide, lauryl peroxide, cyclohexanone peroxide, t-butyl perbenzoate, t-butyl hydroperoxide, t-butyl benzene hydroperoxide, cumene hydroperoxide, t-butyl peroctoate, and the like. Most preferably, the catalyst is methyl ethyl ketone peroxide, which may be obtained from a variety of sources, including Safas Corp. and Ilva Polimeri. Preferably, the catalyst is able to promote a reaction and function in a temperature range of about 0° centigrade to about 60° centigrade. The catalyst or mixture of catalysts is preferably used in an amount of about 0.05 to 3 weight percent, based on the total weight of the resin or blend. For the first layer(s), to allow the coating to penetrate, the amount of catalyst used might be, e.g., 1.5% to 2.0%, while the subsequent layers might contain, e.g., 1.5% to 3.0% since penetration is no longer an issue as it has been achieved in the first layers.

The accelerator is added to decrease the gel time and/or cure time. Suitable accelerators include transition metal salts or complexes such as cobalt naphthanate; and organic bases such as N, N-dimethyl aniline (DMA) and N, N-diethyl aniline (DEA). The accelerators may be used alone or in combination. Particularly preferred are cobalt-based accelerators. Such an accelerator may be obtained from Safas Corp. or Ilva Polimeri.

The accelerator or mixture of accelerators is preferably used in an amount of about 0.05 to 3 weight percent, based on the total weight of the resin or blend. More preferably, the accelerator is used in an amount of about 0.5% to 2% based on the total weight of the resin or blend of resins. The amount of accelerator is selected such that the first coating material permeates the substrate before the coating material sets. This is usually handle in the same manner as the catalyst. Since penetration rates differ depending on the substrate material, the amount of catalyst is carefully adjusted to provide the desired level of penetration. A preferred level of penetration is about 1 mm or greater, more preferably, about 1-5 mm, and most preferably, 1-3 mm. For wood, and particleboard this level of penetration may take about 45 minutes for polyester resin-based coatings. For example, using a cobalt accelerator with an unsaturated polyester which sets in about 45 minutes (complete hardening takes place over 24 hours, or more) the accelerator is probably used at about 1% based on the weight of resin. For PVC and other plastics in which the coating primarily penetrates by dissolving the plastic, more rapid penetration is to be expected, typically in about 15-20 minutes. In all cases, the accelerator is added in sufficient amount to provide setting of the polyester resin in an acceptable time period (typically less than two hours) while allowing the polyester to penetrate into the substrate to form an interface layer. Preferably, the accelerator and catalyst are added in an appropriate ratio to avoid thermal cracking or other undesirable coating attributes.

The second coating layer is formed on the interface layer. The second layer is formed from the first coating material, like the first or interface layer, but further comprises granules to give the material a simulated granite appearance or other textured appearance. The second coating layer may be from about 1 mm to 50 mm in thickness. As for the first layer, the unsaturated polyester (or other resin) is combined with a catalyst and an accelerator to crosslink the polyester to form a hardened resin. Since penetration of the second coating layer is not an issue, the accelerator to resin ratio for the second coating layer is not as critical as for the first coating layer, and can be any suitable amount to allow the coating to set in an acceptable time. As for the first coating layer, the second coating layer is preferably applied by spraying, although it may also be applied by brush, roller, curtain wall, or the like. A spray gun is preferably modified to allow the coating to be sprayed without blockage due to the granules. The resin is usually adjusted to provide a viscosity, which is appropriate for the coating method. This can be done by blending resins of different viscosities or by diluting the resin mixture with a solvent such as styrene. The mixture will usually be in the range of 500 to 5000 centipoise. The granules are mixed with the coating material and applied over the interface layer. Alternatively, particles may be sprinkled on to a layer of the resin before it sets, or a later of resin applied over a layer of particles. This is particularly preferred for larger particles of about 0.5 mm in diameter or greater.

The term “granules,” as used herein, includes chips, particulates, stones, and other similar solid materials. The granules may be premade from the same resin as the coating, or from an acrylic resin or other resin compatible with the coating material. Combinations of different granules may be used. Natural materials, such as granite chips, limestone chips, silica, sand, and mica may also be used. Other suitable granule materials include glass spheres and fiberglass. The ratio of granite to resin is not critical, although is preferably in the range of 0:100 to about 75:25, usually in the range of 25:75 to 75:25. This will cover coatings in which no granules are employed up to coating containing high amounts of granules. Suitable granules are obtained from Gruber Systems, Elyria, Ohio (a mixture of filled polyester and alumina trihydrate), or from The R. J. Marshall Co., Rockledge, Fla. 32955 (a mixture of aliphatic hydrocarbons and resin).

Another, optional component in both the first and second layers is a pigment. One suitable pigment comprises aluminum trihydrate. The pigment is added to mask the colorations of the surface to be sprayed or to give a desired color to the coating. Up to 50% by weight and preferably between about 5 and 25% by weight of alumina trihydrate may be added to the resin. Other tinting pigments, fillers, or the components for providing background colorant to the material and/or selected properties and characteristics to the resin system both during formation and after curing may be added. For example, titanium dioxide or other pigment may be added for additional color. Materials may also be added to reduce the co-efficient of thermal expansion of the cured system or to provide other desired properties.

The process proceeds as follows: first, a layer of the first coating material is applied to the surface of the permeable substrate. Once this infiltration layer has been applied and at least partially absorbed by the substrate, the second layer with particles mixed therein is applied. The second layer is preferably applied prior to complete setting of the first layer so that an interface is formed between the two layers which is well bonded and not visible to the naked eye. One or more layers of the mixture can be applied. Optionally, a layer of resin alone may be used as a final topcoat. The coating may be polished to provide a smooth surface and enhance the visibility of the granules.

It will be appreciated that a wide variety of coated structures may be formed by the above method. By way of example, granite-like pillars can be made in which the substrate is in the form of a cylinder, and may be formed, for example, from cardboard or PVC. It is also contemplated that the first coating material may penetrate the entire substrate layer.

The invention has been described with reference to the preferred embodiment, although partial penetration is preferred. Obviously, modifications and alterations will occur to others upon reading and understanding the preceding detailed description. It is intended that the invention be construed as including all such modifications and alterations insofar as they come within the scope of the appended claims or the equivalents thereof.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A method for forming a simulated granite product on a substrate comprising the steps of
A. Providing a permeable substrate,
B. Applying a thermosetting polymeric composition, a catalyst, and an accelerator to said substrate,
C. Allowing the polymeric composition to penetrate into the substrate and form an interface layer,
D. Applying a layer of resin mixed with granules over the first coating layer, and
E. Curing the resulting laminate.

2. The method for forming a simulated granite product of claim 1 wherein the substrate is selected from the group consisting of wood, particle board, cardboard, PVC plastics, polyesters, acrylic polymers, engineered wood products, engineered synthetic building products, and fiber board.

3. The method for forming a simulated granite product of claim 1 wherein the polymer is selected from the group consisting of polyester resins, neopentyl resins, glycol resins, isophthalic resins, acrylic polymers, and epoxy resin.

4. The method for forming a simulated granite product of claim 1 wherein the catalyst is selected from the group consisting of organic peroxides, hydroperoxides, and azo compounds.

5. The method for forming a simulated granite product of claim 1 wherein the polymeric composition further includes selecting an amount of accelerator to decrease the gel time and/or cure time.

6. The method for forming a simulated granite product of claim 1 wherein the penetration is 0.5 to 4.0 mm.

7. The method for forming a simulated granite product of claim 1 wherein the penetration is 2 to 3 mm.

8. The method for forming a simulated granite product of claim 1 wherein the thermosetting polymeric composition is a polyester resin.

9. A simulated granite product comprising:
A. A permeable substrate,
B. A cured thermosetting polymeric composition penetrating into and adhered to said substrate, the polymeric composition being formed from a thermosetting polymeric composition, a catalyst, and an accelerator,
C. The polymeric composition being penetrated into the substrate about 0.5 to about 4.0 mm and forming an interface layer, and
D. A layer of cured polymeric composition mixed with granules being bonded to the first coating layer.

10. The simulated granite product of claim 9 wherein the polymeric composition is a polyester resin.

11. The simulated granite product of claim 9 wherein the penetration is 2.0 to 3.0 mm.

12. The simulated granite product of claim 9 wherein the substrate is selected from the group consisting of wood, particle board, cardboard, PVC plastics, polyesters, acrylic polymers, engineered wood products, engineered synthetic building products, and fiber board.
